(19) United States
(12) Patent Application Publication
(10) Pub. No.: US 2016/0254616 A1
(43) Pub. Date: Sep. 1, 2016

(54) POWER SUPPLY SYSTEM HAVING MAGNETIC CONNECTOR

(71) Applicant: SPS Inc., Daejeon (KR)

(72) Inventors: Hyun-Jun Kim, Daejeon (KR); Dae-Young Youn, Daejeon (KR); Jung-Gyo Kim, Daejeon (KR)

(21) Appl. No.: 15/148,598

(22) Filed: May 6, 2016

Related U.S. Application Data
(63) Continuation of application No. PCT/KR2014/010676, filed on Nov. 7, 2014.

(30) Foreign Application Priority Data
Nov. 8, 2013 (KR) 10-2013-0135159

(51) Int. Cl. H01R 13/62; H01R 24/60; G05B 11/01; H01R 24/38

(52) U.S. Cl. CPC H01R 13/6205; H01R 24/38; H01R 24/60; G05B 11/01; H01R 2103/00

(57) ABSTRACT

The disclosed technology generally relates to a power supply system, and more particularly to a power supply system having a magnetic connector. In one aspect, the system includes an electronic apparatus that includes a first terminal, a second terminal and a first magnet, wherein the electronic apparatus is configured to receive power through the first and second terminals. The system additionally includes a power supply device that includes a third terminal, a fourth terminal, and a second magnet, wherein the power supply device is configured to supply power through the third and fourth terminals. The power supply system is configured such that when the first magnet and the second magnet are coupled by magnetic attractive force, the first and second terminals of the electronic apparatus make electrical contact with the third and fourth terminals of the power supply device, respectively. The power supply device further includes a power supply blocking circuit configured to allow the power to be supplied from the power supply device to the electronic apparatus upon determining that the first magnet and the second magnet are coupled by the magnetic attractive force.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

1. Field

The present disclosure generally relates to a power supply system, and more particularly to a power supply system having a magnetic connector.

2. Description of the Related Art

Generally, an electronic apparatus may be connected to a power supply device (a device supplying power to the electronic apparatus, such as an adapter, or the like) through a connector to receive the power supplied from the power supply device.

Some connectors having magnets disposed at one side or both sides thereof may be more easily attached and detached more easily compared with general power connector. However, an incomplete or misaligned connection can cause malfunction or damage to an apparatus connected by such connectors. Thus, there is a need for compact magnetic connectors that are configured to prevent malfunction and damage that can result from incomplete or misaligned connections.

### SUMMARY

The present disclosure generally relates to a power supply system, and more particularly to a power supply system having one or more magnetic connectors. More particularly, the present disclosure relates to a power supply system in which a power supply device includes a power supply blocking circuit which allows the supply of power from the power supply device to an electronic device when a magnet of the electronic apparatus and a magnet of the power supply device are in sufficiently coupled. For example, the power supply blocking circuit may allow the supply of power from a V_{CC} terminal of the power supply device when the magnet of an electronic apparatus and the magnet of the power supply device are in direct physical contact, or in contact through an electrical conducting material.

As configured, the disclosed embodiments aim to solve the problems according to the related art as described above, and an object of the present disclosure is to provide a power supply system capable of supplying power upon detection of an accurate connection between magnetic connectors, e.g., when the magnetic connectors accurately contact each other without installing an additional contact terminal in addition to a V_{CC} terminal and a GND terminal required for directly transferring the power.

According to some embodiments, a power supply system having a magnetic connector includes an electronic apparatus and a power supply device. The electronic apparatus includes a first terminal, which can be a V_{CC} terminal, and a second terminal, which can be a GND terminal, and a first magnet. The the power supply device includes a third terminal, which can be a V_{CC} terminal, and a fourth terminal, which can be a GND terminal, and a second magnet. The V_{CC} terminals and the GND terminals of the electronic apparatus contact the V_{CC} terminals and the GND terminals of the power supply device, respectively, by magnetic attractive force between the magnet of the electronic apparatus and the magnet of the power supply device, and the power supply device further includes a power supply blocking circuit allowing the supply of power to the V_{CC} terminal of the power supply device only when the magnet of the electronic apparatus and the magnet of the power supply device are in a contact state.

The power supply system may decide whether or not the magnet of the electronic apparatus and the magnet of the power supply device contact each other using a current flowing through the magnet of the electronic apparatus and the magnet of the power supply device.

The power supply blocking circuit may sense a voltage drop of the magnet of the electronic apparatus to decide whether or not the magnet of the electronic apparatus and the magnet of the power supply device contact each other.

A conductive material may be coated on a surface of the magnet of the electronic apparatus and/or the magnet of the power supply device to facilitate current flow.

The magnet of the electronic apparatus and the GND terminal of the electronic apparatus may be connected to each other through a resistor.

The power supply blocking circuit may allow the supply of the power to the V_{CC} terminal of the power supply device after the magnet of the electronic apparatus and the magnet of the power supply device contact each other and a predetermined time elapses.

The power supply blocking circuit may include a capacitor, and electric charges may be charged in the capacitor when a voltage of the magnet of the electronic apparatus drops by a current flowing through the magnet of the electronic apparatus and the magnet of the power supply device to be in a predetermined range, and the power supply blocking circuit may allow the supply of the power to the V_{CC} terminal of the power supply device when a voltage of the capacitor becomes a predetermined value or more.

A shield plate may be installed on a rear surface of the magnet of the electronic apparatus.

### BRIEF DESCRIPTION OF THE DRAWINGS

FIG. 1 is a plan view of a power supply system according to some embodiments.

FIG. 2 illustrates perspective views of magnetic connectors of an electronic apparatus and a power supply device according to some embodiments.

FIG. 3 is a perspective view of magnetic connectors of an electronic apparatus and a power supply device according to some other embodiments.

FIG. 4 is a schematic block circuit diagram of a magnetic connector according to some embodiments.

FIG. 5 is a circuit diagram of an example of a power supply blocking circuit according to some embodiments.

### DETAILED DESCRIPTION

Some magnetic connectors include multiple terminals, such as a signal terminal S, in addition to a V_{CC} terminal and a GND terminal, as contact terminals of a power supply device, and the supply of the power starts after the GND terminal and the signal terminal S of the power supply device accurately contact a GND terminal of the electronic apparatus, thereby making it possible to prevent a malfunction due to an incomplete contact and a spark generated at the moment of contact. However, because of the multiple connections used, these magnetic connectors can be difficult to miniaturize and can be expensive to manufacture. In the present disclosure, power systems that aim to solve at least these problems are described.

Hereinafter, a power supply system having a power supply blocking circuit according to embodiments of the present disclosure will be described in more detail with reference to the accompanying drawings. The accompanying drawings to be provided below are provided by way of example so that the idea of the present disclosure can be sufficiently transferred to those skilled in the art to which the present disclosure pertains. Therefore, the present disclosure is not limited to the accompanying drawings to be provided below, but may be implemented in other forms.

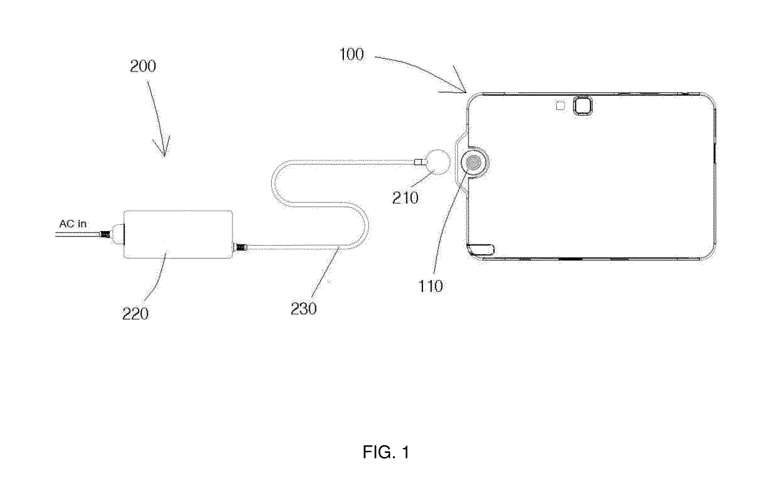

FIG. 1 is a plan view of a power supply system according to embodiments of the present disclosure.

The power supply system according to the present disclosure includes an electronic apparatus 100 and a power supply device 200. An example of the power supply device 200 supplying power to the electronic apparatus 100 includes an adapter or a convertor, e.g., an AC to DC convertor, or a DC to DC converter. Examples of the apparatus 100 include a computing and/or a communication device, e.g. a computer, a smart phone, a cellular phone, and a tablet personal computer, to name a few. The electronic apparatus 100 includes a connector 110 of the electronic apparatus, the power supply device 200 includes a connector 210 of the power supply device, and the connector 110 of the electronic apparatus and the connector 210 of the power supply device are configured to be coupled to each other, such that the power is supplied from the power supply device 200 to the electronic apparatus 100. The connector 210 of the power supply device is connected to a body 220 of the power supply device by a cable 230. The connector 110 of the electronic apparatus and the connector 210 of the power supply device have magnets embedded in one side or both sides thereof, such that they contact each other by the magnetic force (magnetic attractive force) of the magnets. As described herein, magnetic connector may refer to a combination of a connector on the power supply device side, such as the connector 210, and a connector on the electronic apparatus side, such as the connector 110.

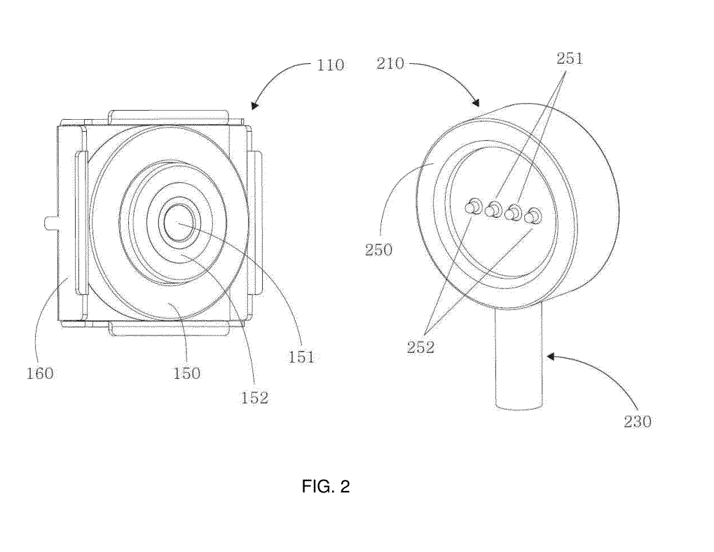

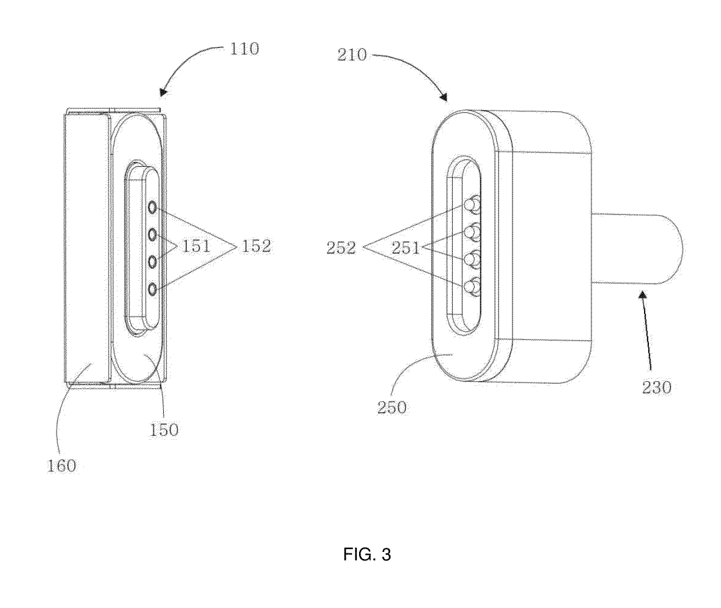

In the present disclosure, the magnetic connector may have various configurations, as described below. FIG. 2 is a perspective view of a first example of an electronic apparatus and a power supply device, and FIG. 3 is a perspective view of a second example of another magnetic connector of an electronic apparatus and a power supply device, according to embodiments. In the first example of FIG. 2, a contact terminal of the connector 110 of the electronic apparatus is formed in a circular shape so that connection between the contact terminals is possible even though two magnetic connectors rotate in any direction, and in the second example of FIG. 3, contact terminals are installed to be symmetrical to each other so that one of the two connecting magnetic connectors may rotate by 180 degrees relative to the other magnetic connector.

The connector 110 of the electronic apparatus, installed in the electronic apparatus 100 includes a magnet 150, one or more first terminals 151, e.g., V_{CC} terminals, and one or more second terminals 152, e.g., ground (GND) terminals.

The connector 210 of the power supply device, installed in the power supply device 200 includes a magnet 250, one or more third terminals 251, e.g., V_{CC} terminals, and one or more fourth terminals 252, e.g., GND terminals.

While in the illustrated embodiment, the first terminals 151 and the third terminals 251 are Vcc terminals, and the second terminals 152 and the fourth terminals 252 are GND terminals, the embodiments are not so limited. The first terminals 151 and the third terminals 251 can be any suitable power terminals at a first voltage, and the second terminals 152 and the fourth terminals 252 can be any power terminals at a second voltage different from the first voltage.

The V_{CC} terminals 151 and the GND terminals 152 of the electronic apparatus contact the V_{CC} terminals 251 and the GND terminals 252 of the power supply device, respectively, by magnetic attractive force between the magnet 150 of the electronic apparatus and the magnet 250 of the power supply device.

A shield plate 160 may be installed on a rear surface of the magnet 150 of the electronic apparatus. In FIGS. 2 and 3, the shield plate 160 is installed over the rear surface and a side surface of the magnet 150 of the electronic apparatus. The shield plate 160 is manufactured by processing a magnetic plate. The shield plate 160 changes a magnetic field directed toward an inner portion of the electronic apparatus toward the magnet 250 of the power supply device to enhance a magnetic field toward the magnet 250 of the power supply device and weaken a magnetic field toward the inner portion of the electronic apparatus 100, thereby protecting an element in the electronic apparatus from magnetic force.

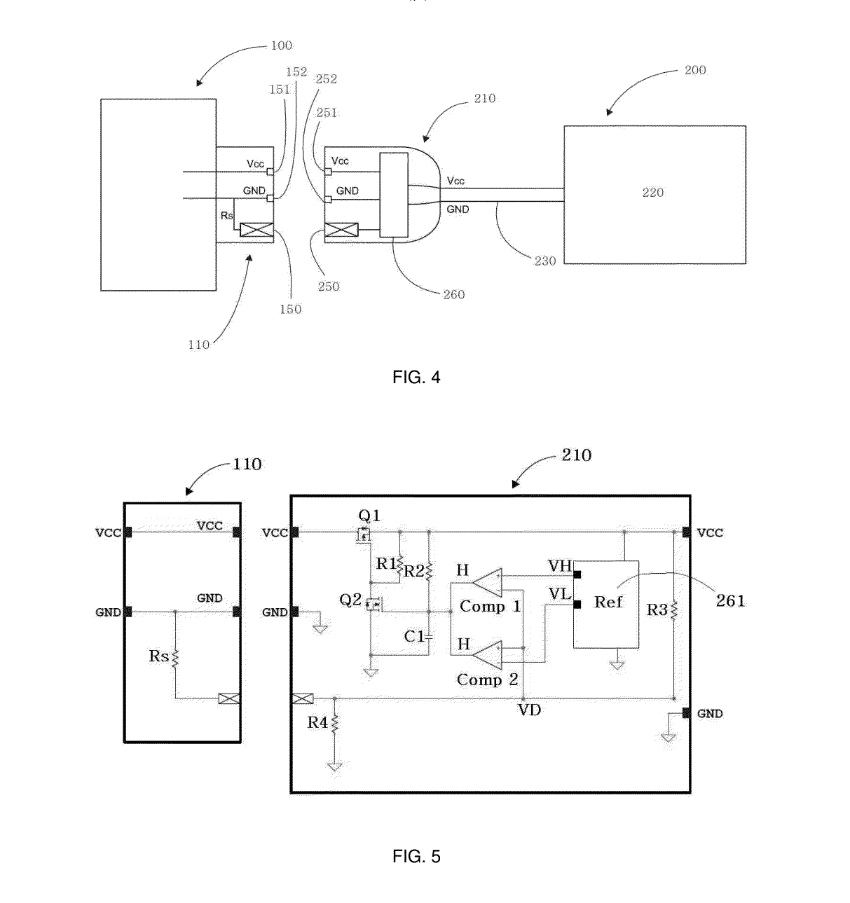

FIG. 4 is a schematic block circuit diagram of a magnetic connector according to some embodiments of the present disclosure.

A power supply blocking circuit 260 is installed in the power supply device 200. Although the power supply blocking circuit 260 is installed in the connector 210 of the power supply device in FIG. 4, the power supply blocking circuit 260 may also be installed in the body 220 of the power supply device or be installed in another portion of the power supply device 200.

The power supply blocking circuit 260 blocks the supply of the power to the V_{CC} terminal of the power supply device before the magnet of the electronic apparatus and the magnet of the power supply device contact each other. When a current flows through the magnet of the electronic apparatus and the magnet of the power supply device due to contact between the magnet of the electronic apparatus and the magnet of the power supply device, the power supply blocking circuit 260 allows the supply of the power to the V_{CC} terminal 251 of the power supply device.

In some embodiments, a voltage drop by the current flowing through the magnet 150 of the electronic apparatus and the magnet 250 of the power supply device is measured to determine whether to allow the supply of the power. When resistances of the magnet 150 of the electronic apparatus and the magnet 250 of the power supply device have certain values, the corresponding values of a voltage drop across the magnets 150 and 250 may be in a predetermined range that is particularly suitable for accurately deciding whether or not to allow the supply of the power. In these embodiments, the voltage drop corresponding to the resistances of the magnets 150 and 250 may alone be used to decide whether or not to allow the supply of the power.

However, in some other embodiments, the resistances of the magnets 150 250 and may be outside the predetermined range that is particularly suitable for accurately deciding whether or not to allow the supply of the power. In these embodiments, additional features may be included. For example, when the resistances of the magnet 150 of the electronic apparatus and the magnet 250 of the power supply device are greater than the predetermined range, the resistances may be decreased by forming a conductive coating on a surface of one or both of the magnets 150 and 250. For example, a conductive coating comprising a metal such as nickel may be formed. On the other hand, when the resistances of the magnet 150 of the electronic apparatus and the magnet 250 of the power supply device are lower than the predetermined range, a separate resistor may be added in series to increase the overall resistance across the magnets 150 and 250 and the separate resistor. In the illustrated embodiment, the separate resistor is included in the current path between the magnet 150 of the electronic apparatus and the GND terminal 152 of the electronic apparatus to increase the overall resistance when the magnet 150 and the GND terminal 152 are electrically connected to each other. Thus, in the illustrated embodiment of FIG. 4, the overall resistance value of the resistor Rs, which represents the series sum of a resistance value of the magnet 150 of the electronic apparatus, a resistance value of the magnet 250 of the power supply device, and a resistance value of an added resistor (the resistor added between the magnet 150 of the electronic apparatus and the GND terminal 152 of the electronic apparatus, may be adjusted to be in the predetermined range by using one or more of the methods described above.

FIG. 5 is a circuit diagram illustrating an example of a power supply blocking circuit according to embodiments of the present disclosure.

The power supply blocking circuit includes comparators Comp 1 and Comp 2, a reference voltage setting unit 261, a switch Q1, and the like, and controls whether to supply the power to the V_{CC} terminal 251 of the power supply device through the switch Q1.

When the magnet 150 of the electronic apparatus and the magnet 250 of the power supply device do not contact each other, a voltage VD is a voltage divided by R3 and R4. When the magnet 150 of the electronic apparatus and the magnet 250 of the power supply device contact each other, a voltage divided by R3 and a parallel resistance (=R4*Rs/R4+Rs) of R4 and RS is applied.

Therefore, when VH is adjusted to be smaller than the voltage divided by R3 and R4 and be larger than the voltage divided by R3 and the parallel resistance of R4 and Rs and VL is adjusted to be smaller than the voltage divided by R3 and the parallel resistance of R4 and Rs, VD becomes a voltage between VH and VL by the contact between the magnet 150 of the electronic apparatus and the magnet 250 of the power supply device. Here, both of the output values of two comparators Comp 1 and Comp 2 become a high state, and charging starts in a capacitor C1. Then, when a voltage of the capacitor C1 becomes a predetermined voltage or more, the switch Q1 is opened, such that the supply of the power to the V_{CC} terminal 251 of the power supply device starts.

Therefore, the power supply blocking circuit 260 according to the present disclosure allows the supply of the power only when the voltage VD changed due to the current flowing out through the magnet 250 of the power supply device after the magnet 150 of the electronic apparatus and the magnet 250 of the power supply device contact each other is in a predetermined range.

In the power supply system having a magnetic connector according to the present disclosure, the power may be allowed to be supplied only when the magnetic connectors accurately contact each other without installing an additional contact terminal in addition to the V_{CC} terminal and the GND terminal required for directly transferring the power, such that structures of the magnetic connectors may be simplified and miniaturized.

While certain embodiments have been described herein, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. Any suitable combination of the elements and acts of the various embodiments described above can be combined to provide further embodiments. The accompanying claims and their equivalents are intended to cover such forms or modifications as would fall within the scope and spirit of the disclosure.

What is claimed is:

1. A power supply system, comprising:
an electronic apparatus comprising a first terminal, a second terminal and a first magnet, wherein the electronic apparatus is configured to receive power through the first and second terminals; and
a power supply device comprising a third terminal, a fourth terminal, and a second magnet, wherein the power supply device is configured to supply power through the third and fourth terminals,
wherein the power supply system is configured such that when the first magnet and the second magnet are coupled by magnetic attractive force, the first and second terminals of the electronic apparatus make electrical contact with the third and fourth terminals of the power supply device, respectively,
wherein the power supply device further comprises a power supply blocking circuit configured to allow the power to be supplied from the power supply device to the electronic apparatus upon determining that the first magnet and the second magnet are coupled together.

2. The power supply system of claim 1, wherein the power supply device further comprises a cable having a connector at one end, wherein the connector comprises the third terminal, the fourth terminal, and the second magnet.

3. The power supply system of claim 1, wherein the first terminal comprises a Vcc terminal of the electronic apparatus, the second terminal comprises a ground (GND) terminal of the electronic apparatus, the third terminal comprises a Vcc terminal of the power supply device and the fourth terminal comprises a ground (GND) terminal of the power supply device.

4. The power supply system of claim 1, wherein the power supply blocking circuit is configured to allow the power to be supplied upon a determination that the first magnet and the second magnet are in direct contact with each other.

5. The power supply system of claim 4, wherein whether or not the first magnet and the second magnet contact each other is determined based on whether a current flows through the first magnet and further through the second magnet.

6. The power supply system of claim 4, wherein the power supply blocking circuit is configured to sense a voltage drop across the first magnet and the second magnet in determining whether or not the first magnet and the second magnet contact each other.

7. The power supply system of claim 1, wherein a conductive material is coated on a surface of the first magnet and/or a surface of the second magnet, such that the first magnet and the second magnet are in indirect contact through the conductive material.

8. The power supply system of claim 1, wherein the first magnet and the first terminal of the electronic apparatus are electrically connected to each other through a resistor.

9. The power supply system of claim 4, wherein the power supply blocking circuit is configured to allow the power to be supplied after a predetermined time elapses after the first magnet and the second magnet contact each other.

10. The power supply system of claim 1, wherein the power supply blocking circuit includes a capacitor configured to be charged when a voltage of the first magnet drops due to a current flowing through the first magnet and the second magnet, and wherein the power supply blocking circuit allows the supply of the power to the first terminal of the power supply device when a voltage of the capacitor reaches or exceeds a predetermined value.

11. The power supply system having a magnetic connector of claim 1, wherein a shield plate is installed on a rear surface of the first magnet.

12. A power supply system, comprising:
a power supply device configured to be coupled to an electronic apparatus, wherein the power supply device comprises a connector, the connector comprising:
a magnet configured to physically and electrically couple to another magnet disposed on the electronic apparatus when the magnet and the another magnet are coupled by a magnetic attraction, and
a plurality of electrical terminals configured such that, when the magnet and the another magnet are physically and electrically coupled to each other, the plurality of electrical terminals contact a corresponding plurality of electrical terminals of the electronic apparatus such that the electronic device receives power supplied by the power supply device,
wherein the power supply device further comprises a power supply blocking circuit configured to prevent power from being supplied by the power supply device to the electronic apparatus when the magnet and the another magnet are not physically and electrically coupled.

13. The power supply of claim 12, wherein the power supply blocking circuit is disposed in the connector.

14. The power supply of claim 12, wherein the power supply device is configured such that a current flows through the magnet and the another magnet when the magnet and the another magnet are physically and electrically coupled to each other, such that a voltage on the magnet drops, whereupon the power supply blocking circuit allows the power to be supplied.

15. The power supply of claim 13, wherein the power supply blocking circuit includes a capacitor configured to be charged when the current flows through the first magnet and the another magnet, and wherein the power supply blocking circuit allows the power to be supplied when a voltage of the capacitor reaches or exceeds a predetermined value.
